(19) United States
(12) Patent Application Publication
(10) Pub. No.: US 2026/0036727 A1
(43) Pub. Date: Feb. 5, 2026

(54) OPTICAL ELEMENTS HAVING IMPROVED ENVIRONMENTAL STABILITY AND METHODS OF MAKING SAME

(71) Applicant: CORNING INCORPORATED, CORNING, NY (US)

(72) Inventors: Gerald Philip Cox, Brockport, NY (US); Jing Du, Pittsford, NY (US); Jue Wang, Pittsford, NY (US)

(21) Appl. No.: 19/270,908

(22) Filed: Jul. 16, 2025

Related U.S. Application Data
(60) Provisional application No. 63/677,068, filed on Jul. 30, 2024.

(51) Int. Cl. G02B 5/08; G02B 1/113

(52) U.S. Cl. CPC G02B 5/0891; G02B 1/113; G02B 5/0858

(57) ABSTRACT

An optical element includes a substrate and a coating supported by the substrate. The coating includes, in an order moving away from the substrate, a period including a high refractive index metal fluoride layer and a low refractive index metal fluoride layer and a capping layer including SiO₂, F—SiO₂, or a combination thereof. The capping layer includes a density greater than or equal to 2.20 g/cm³ and less than 2.28 g/cm³. A method of making the optical element includes depositing the capping layer at a temperature greater than or equal to 200° C. and less than 300° C. and using ion treatment.

This application claims the benefit of priority to U.S. Provisional Patent Application Ser. No. 63/677,068 filed on Jul. 30, 2024, the content of which is relied upon and incorporated herein by reference in its entirety.

### FIELD

The present specification generally relates to optical elements and, in particular, to optical elements having improved environmental stability while maintaining laser durability.

### TECHNICAL BACKGROUND

Optical systems may have various applications in research, medical procedures, and fabrication and microfabrication processes, such as photolithography, among other examples. For instance, an optical system may include one or more laser light sources, such as an excimer laser generating ultraviolet (UV) or deep ultraviolet light (DUV) light, that may be used to expose or apply laser light to a material, such as a substrate. Excimer lasers may produce light in or near the UV spectral region with relatively high peak and average powers and relatively high energies, thereby enabling, for example, photolithography procedures with improved resolution.

Such optical systems utilize laser-durable coatings for optical components. However, conventional ways to improve the service life of an optical coating, such as lowering the density, may be detrimental to the environmental stability (e.g., moisture penetration), thereby causing a spectral shift in the coating.

Therefore, a continuing need exists for optical elements having both improved environmental stability and maintained laser durability.

### SUMMARY

According to a first aspect A1, an optical element comprises: a substrate; and a coating supported by the substrate, wherein the coating comprises, in an order moving away from the substrate: a period comprising a high refractive index metal fluoride layer and a low refractive index metal fluoride layer; and a capping layer comprising SiO₂, F—SiO₂, or a combination thereof, the capping layer comprising a density greater than or equal to 2.20 g/cm³ and less than 2.28 g/cm³.

A second aspect A2 includes the optical element of the first aspect A1, wherein the capping layer comprises a density greater than or equal to 2.22 g/cm³ and less than or equal to 2.26 g/cm³.

A third aspect A3 includes the optical element of the first aspect A1 or the second aspect A2, wherein the capping layer comprises a porosity less than or equal to 2%.

A fourth aspect A4 includes the optical element of any one of the first through third aspects A1-A3, wherein the capping layer comprises a refractive index greater than or equal to 1.56 and less than 1.58.

A fifth aspect A5 includes the optical element of any one of the first through fourth aspects A1-A4, wherein the capping layer comprises a thickness greater than or equal to 30 nm and less than or equal to 100 nm.

A sixth aspect A6 includes the optical element of any one of the first through fifth aspects A1-A5, wherein the high refractive index metal fluoride layer comprises a refractive index greater than 1.60.

A seventh aspect A7 includes the optical element of any one of the first through sixth aspects A1-A6, wherein the low refractive index metal fluoride layer comprises a refractive index greater than or equal to 1.35 and less than or equal to 1.60.

An eighth aspect A8 includes the optical element of any one of the first through seventh aspects A1-A7, wherein the coating comprises, in an order moving away from the substrate: the high refractive index metal fluoride layer; the low refractive index metal fluoride layer; and the capping layer.

A ninth aspect A9 includes the optical element of any one of the first through seventh aspects A1-A7, wherein the coating comprises, in an order moving away from the substrate: the low refractive index metal fluoride layer; the high refractive index metal fluoride layer; and the capping layer.

A tenth aspect A10 includes the optical element of the ninth aspect A9, wherein the coating further comprises another low refractive index metal fluoride layer disposed between the high refractive index metal fluoride layer and the capping layer.

An eleventh aspect A11 includes the optical element of any one of the first through tenth aspects A1-A10, wherein the coating comprises a plurality of the periods such that the high refractive index metal fluoride layer and the low refractive index metal fluoride layer alternate.

A twelfth aspect A12 includes the optical element of the eleventh aspect A11, wherein the coating comprises greater than or equal to 1 period and less than or equal to 10 periods.

A thirteenth aspect A13 includes the optical element of any one of the first through twelfth aspects A1-A12, wherein the high refractive index metal fluoride layer comprises GdF₃, LaF₃, or a combination thereof.

A fourteenth aspect A14 includes the optical element of any one of the first through thirteenth aspects A1-A13, wherein the low refractive index metal fluoride layer comprises AlF₃, MgF₂, CaF₂, LiF, SiO₂, F—SiO₂, or a combination thereof.

A fifteenth aspect A15 includes the optical element of any one of the first through fourteenth aspects A1-A14, wherein each of the high refractive index metal fluoride layer and the low refractive index metal fluoride layer comprise a thickness greater than or equal to 10 nm and less than or equal to 80 nm.

A sixteenth aspect A16 includes the optical element of any one of the first through fifteenth aspects A1-A15, wherein the coating comprises an anti-reflective coating, the anti-reflective coating comprising a reflectance less than or equal to 0.5%, as measured at a wavelength of 150 nm to 300 nm, inclusive of endpoints, and at an angle of incidence of 0 degrees to 75 degrees, inclusive of endpoints.

A seventeenth aspect A17 includes the optical element of any one of the first through fifteenth aspects A1-A15, wherein the coating comprises a partial-reflective coating, the partial-reflective coating comprising a reflectance greater than or equal to 0.5%, as measured at a wavelength of 150 nm to 300 nm, inclusive of endpoints, and at an angle of incidence of 0 degrees to 75 degrees, inclusive of endpoints.

An eighteenth aspect A18 includes the optical element of any one of the first through fifteenth aspects A1-A15, wherein the coating comprises a first anti-reflective coating disposed on a first major surface of the substrate and a second anti-reflective coating disposed on a second major surface of the substrate opposite the first major surface, each of the first anti-reflective coating and the second anti-reflective coating comprising a reflectance less than or equal to 0.5%, as measured at a wavelength of 150 nm to 300 nm, inclusive of endpoints, and at an angle of incidence of 0 degrees to 75 degrees, inclusive of endpoints.

A nineteenth aspect A19 includes the optical element of the eighteenth aspect A18, wherein the optical element comprises a laser window.

A twentieth aspect A20 includes the optical element of any one of the first through fifteenth aspects A1-A15, wherein the coating comprises a partial-reflective coating disposed on a first major surface of the substrate and an anti-reflective coating disposed on a second major surface of the substrate, the partial-reflective coating comprising a reflectance greater than or equal to 0.5%, as measured at a wavelength of 150 nm to 300 nm, inclusive of endpoints, and at an angle of incidence of 0 degrees to 75 degrees, inclusive of endpoints, the anti-reflective coating comprising a reflectance less than or equal to 0.5%, as measured at a wavelength of 150 nm to 300 nm, inclusive of endpoints, and at an angle of incidence of 0 degrees to 75 degrees, inclusive of endpoints.

A twenty-first aspect A21 includes the optical element of the twentieth aspect A20, wherein the optical element comprises a beam splitter.

A twenty-second aspect A22 includes the optical element of any one of the first through twenty-first aspects A1-A21, wherein the coating comprises a thickness greater than or equal to 75 nm and less than or equal to 500 nm.

A twenty-third aspect A23 includes the optical element of any one of the first through twenty-second aspects A1-A22, wherein the substrate comprises MgF₂, CaF₂, SiO₂, F—SiO₂, or a combination thereof.

According to a twenty-fourth aspect A24, an ultraviolet lithography system includes the optical element of any one of the first through twenty-third aspects A1-A23.

According to a twenty-fifth aspect A25, a method for making an optical element having a coating thereon, the method comprises: applying a period on a substrate, the period comprising a high refractive index metal fluoride layer and a low refractive index metal fluoride layer; and depositing a capping layer comprising SiO₂, F—SiO₂, or a combination thereof on the period at a temperature greater than or equal to 200° C. and less than 300° C. and using ion treatment, the capping layer comprising a density greater than or equal to 2.20 g/cm³ and less than 2.28 g/cm³.

A twenty-sixth aspect A26 includes the method of the twenty-fifth aspect A25, wherein the capping layer is deposited at a temperature greater than or equal to 220° C. and less than or equal to 280° C.

A twenty-seventh aspect A27 includes the method of the twenty-fifth aspect A25 or the twenty-sixth aspect A26, wherein the ion treatment comprises an in-situ or post-deposition plasma ion treatment.

A twenty-eighth aspect A28 includes the method of the twenty-seventh aspect A27, wherein the plasma ion treatment comprises an advanced plasma source, the advanced plasma source comprising a voltage greater than 110 V and less than or equal to 160 V.

A twenty-ninth aspect A29 includes the method of any one of the twenty-fifth through twenty-eighth aspects A25-A28, wherein each of the high refractive index metal fluoride material and the low refractive index material are applied at a temperature greater than or equal to 200° C. and less than or equal to 300° C.

A thirtieth aspect A30 includes the method of any one of the twenty-fifth through twenty-ninth aspects A25-A29, wherein the coating comprises, in an order moving away from the substrate: the high refractive index metal fluoride layer; the low refractive index metal fluoride layer; and the capping layer.

A thirty-first aspect A31 includes the method of any one of the twenty-fifth through twenty-ninth aspects A25-A29, wherein the coating comprises, in an order moving away from the substrate: the low refractive index metal fluoride layer; the high refractive index metal fluoride layer; and the capping layer.

A thirty-second aspect A32 includes the method of the thirty-first aspect A31, wherein the coating further comprises another low refractive index metal fluoride layer disposed between the high refractive index metal fluoride layer and the capping layer.

A thirty-third aspect A33 includes the method of any one of the twenty-fifth through thirty-second aspects A25-A32, wherein the coating comprises a plurality of the periods such that the high refractive index metal fluoride layer and the low refractive index metal fluoride layer alternate.

A thirty-fourth aspect A34 includes the method of the thirty-third aspect A33, wherein the coating comprises greater than or equal to 1 period and less than or equal to 10 periods.

A thirty-fifth aspect A35 includes the method of any one of the twenty-fifth through thirty-fourth aspects A25-A34, wherein the high refractive index metal fluoride layer comprises GdF₃, LaF₃, or a combination thereof.

A thirty-sixth aspect A36 includes the method of any one of the twenty-fifth through thirty-fifth aspects A25-A35, wherein the low refractive index metal fluoride layer comprises AlF₃, MgF₂, CaF₂, LiF, SiO₂, F—SiO₂, or a combination thereof.

Additional features and advantages of the optical elements and methods of making same described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 is a schematic illustration of an optical element having a coating thereon, according to embodiments described herein;

FIG. 2 is a schematic illustration of another optical element having a coating thereon, according to embodiments described herein;

FIG. 3 is a schematic illustration of an optical element including a partial-reflective coating, according to embodiments described herein;

FIG. 4 is a schematic illustration of a beam splitter, according to embodiments described herein;

FIG. 5 is a schematic illustration of a laser window, according to embodiments described herein;

FIG. 6 is a schematic illustration of an ultraviolet lithography system, according to embodiments described herein;

FIG. 7 is a flow chart for a method of making an optical element having a coating thereon, according to embodiments described herein;

FIG. 8 is a plot of reflectance (y-axis; in percentage (%)) versus wavelength (x-axis; in nanometers (nm)) of a comparative optical element;

FIG. 9 is a plot of reflectance (y-axis; in percentage (%)) versus wavelength (x-axis; in nanometers (nm)) of exemplary optical elements, according to embodiments described herein; and

FIG. 10 is a plot of normalized power (y-axis; unitless) versus accelerated lifetime (x-axis; in billion pulses (Bp)) of a comparative optical element and an exemplary optical element, according to embodiments described herein.

### DETAILED DESCRIPTION

Reference will now be made in detail to various embodiments of optical elements having improved environmental stability while maintaining laser durability.

According to embodiments, an optical element includes a substrate and a coating supported by the substrate. The coating includes, in an order moving away from the substrate, a period including a high refractive index metal fluoride layer and a low refractive index metal fluoride layer and a capping layer including SiO₂, F—SiO₂, or a combination thereof. The capping layer includes a density greater than or equal to 2.20 g/cm³ and less than 2.28 g/cm³.

According to embodiments, a method for making an optical element having a coating thereon includes applying a period on a substrate and depositing a capping layer including SiO₂, F—SiO₂, or a combination thereof on the period at a temperature greater than or equal to 200° C. and less than 300° C. and using ion treatment. The period includes a high refractive index metal fluoride layer and a low refractive index metal fluoride layer. The capping layer includes a density greater than 2.20 and less than 2.28 g/cm³.

Various embodiments of optical elements and methods of making same will be described herein with specific reference to the appended drawings.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

“Density,” as described herein, is measured by the buoyancy method of ASTM C693-93.

The term “refractive index” refers to the refractive index at a wavelength of 587.56 nm (n_{d}) for optical materials with an Abbe number greater than 25 (moderately-dispersive optical materials). Furthermore, the term “refractive index” refers to the refractive index at a wavelength of 650 nm for optical materials with an Abbe number less than or equal to 25 (highly-dispersive optical materials)

The Abbe number, which can also be referred to as the V-number, is a measure of a material's dispersion (change of refractive index versus wavelength), with high Abbe numbers indicating low dispersion. The Abbe number of a material is calculated using the following Eq. (1):

$$V = \frac{nd - I}{nf - nc} , \qquad ( 1 )$$

wherein V is the Abbe number, nc is the refractive index of the material at a wavelength of 656.3 nm, nd is the refractive index of the material at a wavelength of 587.56 nm, and nf is the refractive index of the material at a wavelength of 486.1 nm.

“Porosity,” as described herein, refers to to a small fraction of voids in a coating material. It is defined as the ratio of the volume of voids divided by the total volume of the coating material. As used herein, porosity is calculated using the following Eq. (2):

$$p = ( {n}_{d} - {n}_{f} ) / {n}_{d} , \qquad ( 2 )$$

wherein p is equal to porosity.

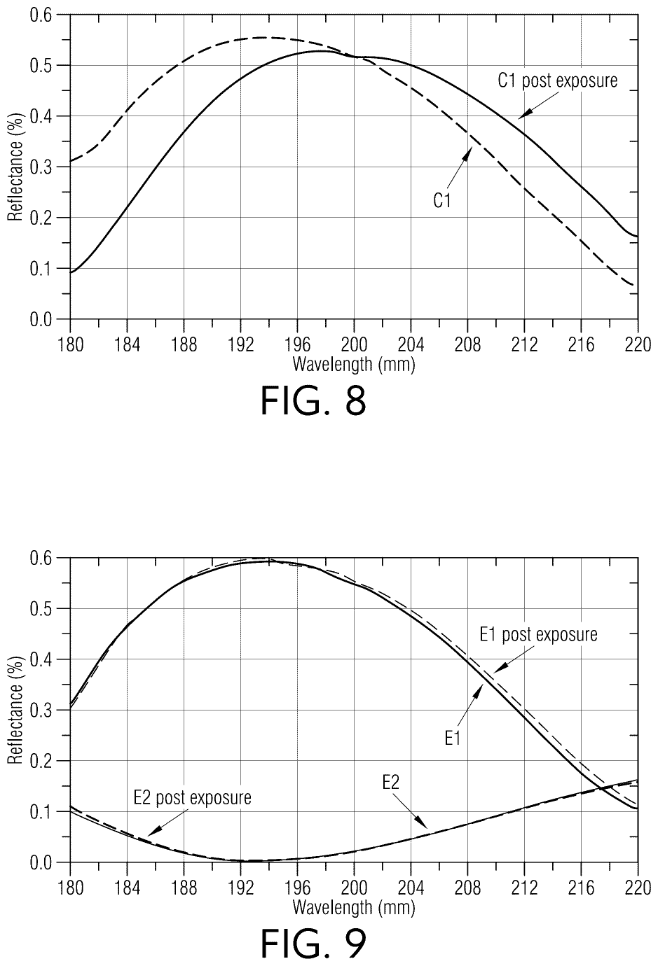

“Reflectance,” as described herein, is measured by using the steps described in ‘Variable angle spectroscopic ellipsometry: A non-destructive characterization technique for ultrathin and multilayer materials’ to J. A. Woollam. In particular, as described herein, reflectance is measured at an angle of incidence of 45 degrees and S-polarization. The reflectance measurement procedure for reflectance data presented in FIG. 8 and FIG. 9 includes the following steps: (1) load a CaF₂ substrate coated with a coating onto a vacuum chuck-holding stage; (2) align the sample to a Φ3 mm test beam in both X-Y plane and Z plane after completion of N₂ gas purging; 3( ) take 1^{st} intensity reading by moving the sample out of the test beam path in an S-pol configuration; (4) take 2^{nd} intensity reading by moving the sample into the test beam path at an angle of incidence of 45 degrees; and (5) derive the reflectance by taking the ratio of the 2^{nd} intensity over the 1^{st} intensity.

Transmission data (total transmission and diffuse transmission) was measured with a Lambda 950 UV/Vis Spectrophotometer manufactured by PerkinElmer Inc. (Waltham, Massachusetts USA). The Lambda 950 apparatus was fitted with a 150 mm integrating sphere. Data was collected using an open beam baseline and a Spectralon® reference reflectance disk. For total transmission (Total Tx), the sample is fixed at the integrating sphere entry point. For diffuse transmission (Diffuse Tx), the Spectralon® reference reflectance disk over the sphere exit port is removed to allow on-axis light to exit the sphere and enter a light trap. A zero offset measurement is made, with no sample, of the diffuse portion to determine efficiency of the light trap. To correct diffuse transmission measurements, the zero offset contribution is subtracted from the sample measurement using the equation: Diffuse Tx=Diffuse_{Measured}−(Zero Offset*(Total Tx/100)). The scatter ratio is measured for all wavelengths as: (% Diffuse Tx/% Total Tx).

The term “transmission,” as used herein, refers to the average of transmission measurements made at a fixed wavelength of 193.4 nm over a period of time.

The term “normalized power,” as used herein, refers to a sum of reflectance and transmission normalized to a ratio scale from 0 to 1.

The term “environmental stability,” as used herein, refers to the reduction or prevention of moisture penetration in a material, thereby reducing or preventing spectral shift (e.g., shift). “Improved environmental stability,” as used herein, refers to a spectral shift less than 1 nm, as measured at peak reflectance, after exposure to given environmental conditions.

The term “laser durability,” as used herein, refers to a material's ability to maintain its original properties after being exposed to a laser (i.e., used), such as in an ultraviolet lithography system. “Maintaining laser durability” or “maintained laser durability,” as used herein, refer to less than 1% normalized power reduction after an accelerated lifetime of about 0.6 Bp.

As semiconductor processing progresses to 45 nm node processes and beyond, the application of excimer lasers (e.g., 193 nm excimer laser) with increasing power and repetition rate require laser-durable coatings for optical components. A conventional way to improve the service life of an optical coating is to reduce the inherent stresses of top layers of the coating, which may be achieved by lowering the density. However, lowering the density may allow moisture to penetrate the coating due to increased porosity, thereby causing a spectral shift (e.g., red shift) in the coating.

Disclosed herein are coatings and methods of making an optical element having a coating thereon that mitigate the aforementioned problems. Specifically, the coatings disclosed herein comprise a capping layer having a specified density (e.g., greater than or equal to 2.20 g/cm³ and less than 2.28 g/cm³) to achieve a relatively low porosity (e.g., less than or equal to 2%), which results in a coating having improved environmental stability while maintaining laser durability. The desired density may be achieved by depositing the capping layer at a temperature greater than or equal to 200° C. and less than 300° C. and using ion treatment.

Referring now to FIG. 1, an optical element is shown at 100. The optical element 100 includes a substrate 102 and a coating 104 supported by the substrate 102. The substrate 102 may comprise MgF₂, CaF₂, SiO₂, F—SiO₂, or a combination thereof. In embodiments, the substrate 102 may have a thickness greater than or equal to 1 mm and less than or equal to 10 mm, greater than or equal to 1 mm and less than or equal to 8 mm, greater than or equal to 1 mm and less than or equal to 6 mm, greater than or equal to 1 mm and less than or equal to 4 mm, greater than or equal to 1 mm and less than or equal to 2 mm, greater than or equal to 3 mm and less than or equal to 10 mm, greater than or equal to 3 mm and less than or equal to 8 mm, greater than or equal to 3 mm and less than or equal to 6 mm, greater than or equal to 3 mm and less than or equal to 4 mm, greater than or equal to 5 mm and less than or equal to 10 mm, greater than or equal to 5 mm and less than or equal to 8 mm, greater than or equal to 5 mm and less than or equal to 6 mm, greater than or equal to 7 mm and less than or equal to 10 mm, greater than or equal to 7 mm and less than or equal to 8 mm, or even greater than or equal to 9 mm and less than or equal to 10 mm, or any and all sub-ranges formed from any of these endpoints.

The coating 104 may comprise a thickness greater than or equal to 75 nm and less than or equal to 500 nm. The coating 104 may comprise a thickness greater than or equal to 75 nm, greater than or equal to 125 nm, greater than or equal to 175 nm, greater than or equal to 225 nm, greater than or equal to 275 nm, or even greater than or equal to 325 nm. The coating 104 may comprise a thickness less than or equal to 500 nm, less than or equal to 400 nm, less than or equal to 300 nm, or even less than or equal to 200 nm. The coating 104 may comprise a thickness greater than or equal to 75 nm and less than or equal to 500 nm, greater than or equal to 75 nm and less than or equal to 400 nm, greater than or equal to 75 nm and less than or equal to 300 nm, greater than or equal to 75 nm and less than or equal to 200 nm, greater than or equal to 125 nm and less than or equal to 500 nm, greater than or equal to 125 nm and less than or equal to 400 nm, greater than or equal to 125 nm and less than or equal to 300 nm, greater than or equal to 125 nm and less than or equal to 200 nm, greater than or equal to 175 nm and less than or equal to 500 nm, greater than or equal to 175 nm and less than or equal to 400 nm, greater than or equal to 175 nm and less than or equal to 300 nm, greater than or equal to 175 nm and less than or equal to 200 nm, greater than or equal to 225 nm and less than or equal to 500 nm, greater than or equal to 225 nm and less than or equal to 400 nm, greater than or equal to 225 nm and less than or equal to 300 nm, greater than or equal to 275 nm and less than or equal to 500 nm, greater than or equal to 275 nm and less than or equal to 400 nm, greater than or equal to 275 nm and less than or equal to 300 nm, greater than or equal to 325 nm and less than or equal to 500 nm, or even greater than or equal to 325 nm and less than or equal to 400 nm, or any and all sub-ranges formed from any of these endpoints.

The coating 104 may comprise, in an order moving away from the substrate 102, a period 108, and a capping layer 110. The period 108 comprises a high refractive index metal fluoride layer 108a and a low refractive index metal fluoride layer 108b. High refractive index metal fluoride layer 108a comprises a refractive index that is greater than the refractive index of low refractive index metal fluoride layer 108b.

As used herein, the term “high refractive index,” in embodiments, refers to a refractive index greater than 1.60. Accordingly, in embodiments, the high refractive index metal fluoride layer 108a may comprise a refractive index greater than 1.60, greater than or equal to 1.70, greater than or equal to 1.80, greater than or equal to 1.90, or even greater than or equal to 2.00. In embodiments, the high refractive index metal fluoride layer 108a may comprise GdF₃, LaF₃, or a combination thereof.

As used herein, the term “low refractive index,” in embodiments, refers to a refractive index greater than or equal to 1.35 and less than or equal to 1.60. Accordingly, in embodiments, the low refractive index metal fluoride layer 108b may comprise a refractive index greater than or equal to 1.35 and less than or equal to 1.60, greater than or equal to 1.35 and less than or equal to 1.55, greater than or equal to 1.35 and less than or equal to 1.50, greater than or equal to 1.40 and less than or equal to 1.60, greater than or equal to 1.40 and less than or equal to 1.55, greater than or equal to 1.40 and less than or equal to 1.50, greater than or equal to 1.45 and less than or equal to 1.60, greater than or equal to 1.45 and less than or equal to 1.55, or even greater than or equal to 1.45 and less than or equal to 1.50, or any and all sub-ranges formed from any of these endpoints. In embodiments, the low refractive index metal fluoride layer 108b may comprise AlF₃, MgF₂, CaF₂, LiF, SiO₂, F—SiO₂, or a combination thereof.

in addition to the density of capping layer 110, the density of each of the high refractive index metal fluoride layer 108a and the low refractive index metal fluoride layer 108b may also contribute to the environmental stability of coating 104. In particular, lowering the density of the high refractive index metal fluoride layer 108a and the low refractive index metal fluoride layer 108b advantageously reduces stress in the coating, which improves the service life of the coating. But, lowering the density of these layers may increase the porosity of the coating, which disadvantageously allows moisture to penetrate the coating. Therefore, in the embodiments disclosed herein, the density of each of the high refractive index metal fluoride layer 108a and the low refractive index metal fluoride layer 108b is from about 3.0 g/cm³ to about 6.9 g/cm³, or about 3.2 g/cm³ to about 6.8 g/cm³, or about 3.4 g/cm³ to about 6.4 g/cm³, or about 3.6 g/cm³ to about 6.2 g/cm³, or about 3.8 g/cm³ to about 6.0 g/cm³, or about 4.0 g/cm³ to about 5.8 g/cm³, or about 4.2 6/cm³, to about 5.6 g/cm³, or about 4.4 g/cm³ to about 5.4 g/cm³, or about 4.6 g/cm³ to about 5.2 g/cm³, or about 4.8 g/cm³ to about 5.0 g/cm³, or any range encompassing these endpoints. Such allows coating 104 to comprise a porosity less than or equal to 2%, less than or equal to 1.5%, less than or equal to 1%, or even less than or equal to 0.5%.

In embodiments, each of the high refractive index metal fluoride layer 108a and the low refractive index metal fluoride layer 108b may comprise a thickness greater than or equal to 10 nm and less than or equal to 80 nm. In embodiments, each of the high refractive index metal fluoride layer 108a and the low refractive index metal fluoride layer 108b may comprise a thickness greater than or equal to 10 nm, greater than or equal to 15 nm, greater than or equal to 20 nm, greater than or equal to 25 nm, or even greater than or equal to 30 nm. In embodiments, each of the high refractive index metal fluoride layer 108a and the low refractive index metal fluoride layer 108b may comprise a thickness less than or equal to 80 nm, less than or equal to 70 nm, less than or equal to 60 nm, less than or equal to 50 nm, or even less than or equal to 40 nm. In embodiments, each of the high refractive index metal fluoride layer 108a and the low refractive index metal fluoride layer 108b may comprise a thickness greater than or equal to 10 nm and less than or equal to 80 nm, greater than or equal to 10 nm and less than or equal to 70 nm, greater than or equal to 10 nm and less than or equal to 60 nm, greater than or equal to 10 nm and less than or equal to 50 nm, greater than or equal to 10 nm and less than or equal to 40 nm, greater than or equal to 15 nm and less than or equal to 80 nm, greater than or equal to 15 nm and less than or equal to 70 nm, greater than or equal to 15 nm and less than or equal to 60 nm, greater than or equal to 15 nm and less than or equal to 50 nm, greater than or equal to 15 nm and less than or equal to 40 nm, greater than or equal to 20 nm and less than or equal to 80 nm, greater than or equal to 20 nm and less than or equal to 70 nm, greater than or equal to 20 nm and less than or equal to 60 nm, greater than or equal to 20 nm and less than or equal to 50 nm, greater than or equal to 20 nm and less than or equal to 40 nm, greater than or equal to 25 nm and less than or equal to 80 nm, greater than or equal to 25 nm and less than or equal to 70 nm, greater than or equal to 25 nm and less than or equal to 60 nm, greater than or equal to 25 nm and less than or equal to 50 nm, greater than or equal to 25 nm and less than or equal to 40 nm, greater than or equal to 30 nm and less than or equal to 80 nm, greater than or equal to 30 nm and less than or equal to 70 nm, greater than or equal to 30 nm and less than or equal to 60 nm, greater than or equal to 30 nm and less than or equal to 50 nm, or even greater than or equal to 30 nm and less than or equal to 40 nm, or any and all sub-ranges formed from any of these endpoints.

Referring back to FIG. 1, in embodiments, the coating 104 may comprise, in an order moving away from the substrate, the high refractive index metal fluoride layer 108a, the low refractive index metal fluoride layer 108b, and the capping layer 110. That is, the high refractive index metal fluoride layer 108a may be disposed on the substrate 102 and in between the substrate 102 and the low refractive index metal fluoride layer 108b. The capping layer 110 may be disposed on the low refractive index metal fluoride layer 108b. In embodiments, the term “disposed” may refer to deposited.

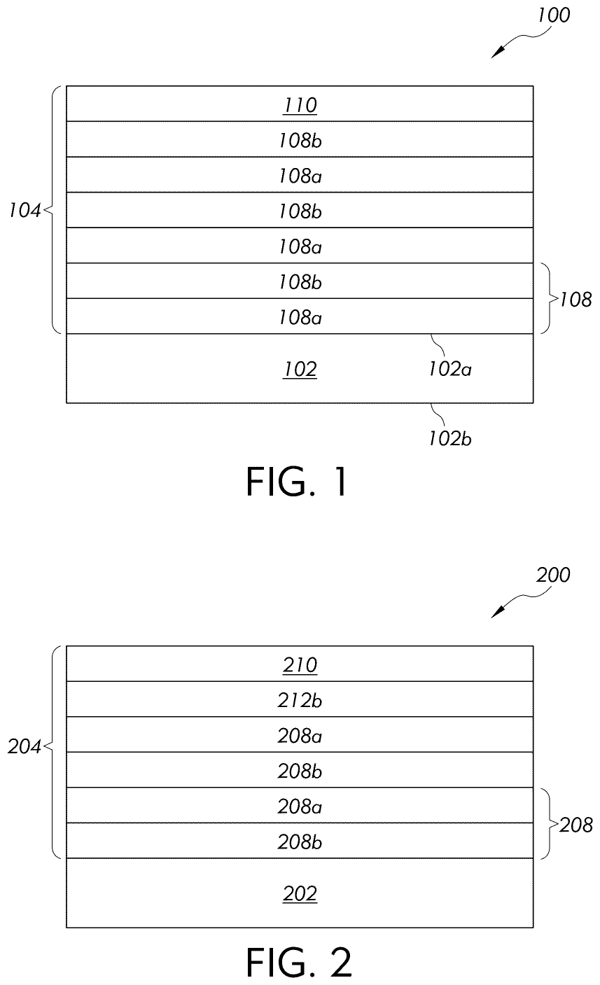

In other embodiments, referring now to FIG. 2, an optical element 200 includes a substrate 202 and a coating 204 supported by the substrate 202. The coating 204 may comprise, in an order moving away from the substrate 202, a period 208 comprising a low refractive index metal fluoride layer 208b and a high refractive index metal fluoride layer 208a. The coating 204 may comprise, in an order moving away from the substrate 202, the low refractive index metal fluoride layer 208b, the high refractive index metal fluoride layer 208a, and the capping layer 210. That is, the low refractive index metal fluoride layer 208b may be disposed on the substrate 202 and in between the substrate 202 and the high refractive index metal fluoride layer 208a. The capping layer 210 may be disposed on the high refractive index metal fluoride layer 208a. In some embodiments, as shown in FIG. 2, the optical element 200 may include another low refractive index metal fluoride layer 212b disposed between the high refractive index metal fluoride layer 208a and the capping layer 210. The capping layer 210 may be disposed on the another low refractive index metal fluoride layer 212b. The another low refractive index metal fluoride layer 212b may not be part of a period including a corresponding high refractive index metal fluoride layer.

The optical element 200 of FIG. 2 including the substrate 202, the coating 204, the high refractive index metal fluoride layer 208a, the low refractive index metal fluoride layers 208b, 212b, and the capping layer 210 of FIG. 2 may have the same or similar materials and properties as the optical element 100 of FIG. 1 including the substrate 102, the coating 104, the high refractive index metal fluoride layer 108a, the low refractive index metal fluoride layer 108b, and the capping layer 110. As such, except where differences are noted, any description herein with respect to the optical element 100 may apply to the optical element 200.

Referring back to FIG. 1, the coating 104 may comprise a plurality of periods 108 such that the high refractive index metal fluoride layer 108a and the low refractive index metal fluoride layer 108b alternate. For example, the coating 104 of the optical element 100 of FIG. 1 includes 3 periods 108. As another example, the coating 204 of the optical element 200 of FIG. 2 includes 2 periods 208. In embodiments, the coating 104 may comprise greater than or equal to 1 period and less than or equal to 10 periods. In embodiments, the coating 104 may comprise greater than or equal to 1 period, greater than or equal to 2 periods, greater than or equal to 3 periods, greater than or equal to 4 periods, or even greater than or equal to 5 periods. In embodiments, the coating 104 may comprise less than or equal to 10 periods, less than or equal to 8 periods, less than or equal to 6 periods, less than or equal to 4 periods, or even less than or equal to 2 periods. In embodiments, the coating may comprise greater than or equal to 1 period and less than or equal to 10 periods, greater than or equal to 1 period and less than or equal to 8 periods, greater than or equal to 1 period and less than or equal to 6 periods, greater than or equal to 1 period and less than or equal to 4 periods, greater than or equal to 1 period and less than or equal to 2 periods, greater than or equal to 2 periods and less than or equal to 8 periods, greater than or equal to 2 periods and less than or equal to 6 periods, greater than or equal to 2 periods and less than or equal to 4 periods, greater than or equal to 3 periods and less than or equal to 8 periods, greater than or equal to 3 periods and less than or equal to 6 periods, greater than or equal to 3 periods and less than or equal to 4 periods, greater than or equal to 4 periods and less than or equal to 8 periods, greater than or equal to 4 periods and less than or equal to 6 periods, greater than or equal to 5 periods and less than or equal to 8 periods, or even greater than or equal to 5 periods and less than or equal to 6 periods, or any and all sub-ranges formed from any of these endpoints.

Referring again to FIG. 1, the capping layer 110 may comprise SiO₂, F—SiO₂, or a combination thereof “F—SiO₂” refers to F-doped SiO₂. As described herein, the capping layer 110 may comprise a minimum density (e.g., greater than or equal to 2.20 g/cm³) to achieve a relatively low porosity (e.g., less than or equal to 2%) of the coating 104, which results in the coating having improved environmental stability. The density of the capping layer 110 may be limited (e.g., less than 2.28 g/cm³) to reduce inherent stresses, thereby maintaining laser durability. Accordingly, in embodiments, the capping layer 110 may comprise a density greater than or equal to 2.20 g/cm³ and less than 2.28 g/cm³. In embodiments, the capping layer 110 may comprise a density greater than or equal to 2.22 g/cm³ and less than or equal to 2.26 g/cm³. In embodiments, the capping layer 110 may comprise a density greater than or equal to 2.20 g/cm³, greater than or equal to 2.21 g/cm³, greater than or equal to 2.22 g/cm³, greater than or equal to 2.23 g/cm³, or even greater than or equal to 2.24 g/cm³. In embodiments, the capping layer 110 may comprise a density less than 2.28 g/cm³, less than or equal to 2.27 g/cm³, less than or equal to 2.26 g/cm³, or even less than or equal to 2.25 g/cm³. In embodiments, the capping layer 110 may comprise a density greater than or equal to 2.20 g/cm³ and less than 2.28 g/cm³, greater than or equal to 2.20 g/cm³ and less than or equal to 2.27 g/cm³, greater than or equal to 2.20 g/cm³ and less than or equal to 2.26 g/cm³, greater than or equal to 2.20 g/cm³ and less than or equal to 2.25 g/cm³, greater than or equal to 2.21 g/cm³ and less than 2.28 g/cm³, greater than or equal to 2.21 g/cm³ and less than or equal to 2.27 g/cm³, greater than or equal to 2.21 g/cm³ and less than or equal to 2.26 g/cm³, greater than or equal to 2.21 g/cm³ and less than or equal to 2.25 g/cm³, greater than or equal to 2.22 g/cm³ and less than 2.28 g/cm³, greater than or equal to 2.22 g/cm³ and less than or equal to 2.27 g/cm³, greater than or equal to 2.22 g/cm³ and less than or equal to 2.26 g/cm³, greater than or equal to 2.22 g/cm³ and less than or equal to 2.25 g/cm³, greater than or equal to 2.23 g/cm³ and less than 2.28 g/cm³, greater than or equal to 2.23 g/cm³ and less than or equal to 2.27 g/cm³, greater than or equal to 2.23 g/cm³ and less than or equal to 2.26 g/cm³, greater than or equal to 2.23 g/cm³ and less than or equal to 2.25 g/cm³, greater than or equal to 2.24 g/cm³ and less than 2.28 g/cm³, greater than or equal to 2.24 g/cm³ and less than or equal to 2.27 g/cm³, greater than or equal to 2.24 g/cm³ and less than or equal to 2.26 g/cm³, or even greater than or equal to 2.24 g/cm³ and less than or equal to 2.25 g/cm³, or any and all sub-ranges formed from any of these endpoints.

Porosity decreases as density increases. The relatively low porosity (e.g., less than or equal to 2%) of the coating 104 described herein reduces or prevents moisture penetration, thereby reducing or preventing spectral shift (e.g., red shift) in the coating 104. In embodiments, the coating 104 may comprise a porosity less than or equal to 2%, less than or equal to 1.5%, less than or equal to 1%, or even less than or equal to 0.5%.

Refractive index increases as density increases and, thus, as porosity decreases. Thus, the refractive index of capping layer 110 is based on its density (and, thus, porosity). In embodiments, the capping layer 110 may comprise a refractive index greater than or equal to 1.56 and less than 1.58, or greater than or equal to 1.57 and less than or equal to 1.58. The refractive index of capping layer 110 should be such so that the corresponding density of capping layer 110 matches (or is close to) the density of substrate 102 so that capping layer 110 and substrate 102 are similar in their compactness and solidity. This provides the improved environmental stability to substrate 102. But the density of each of capping layer 110 and substrate 102 is limited by the materials of these components, which, thus, also limits the refractive index of capping layer 110. Therefore, in embodiments, the refractive index of capping layer 110 is within the range of greater than or equal to 1.56 and less than 1.58 so that the density of capping layer 110 matches (or is close to) the density of substrate 102.

In embodiments, the coating 104 may comprise certain properties (e.g., partial reflective properties, anti-reflective properties) based upon the components and materials of the coating 104. For example, the number of high refractive index metal fluoride layers and low refractive index metal fluoride layers and/or the material of each layer may be modified in the coating 104 to achieve a desired reflectivity. In embodiments, a partial-reflective coating and an anti-reflective coating may both comprise the same materials in each of their high refractive index metal fluoride layers and low refractive index metal fluoride layers, however, the the partial-reflective coating may include more high and low refractive index metal fluoride layers overall than the anti-reflective coating, thereby resulting in partial-reflectivity instead of the anti-reflectivity.

In embodiments, the coating 104 may comprise an anti-reflective coating comprising a reflectance of less than or equal to 0.5%, as measured at a wavelength within a range from 150 nm to 300 nm, inclusive of the endpoints, and at an angle of incidence within a range from 0 degrees to 75 degrees, inclusive of the endpoints. In embodiments, the anti-reflective coating comprising a reflectance of less than or equal to 0.5%, as measured at every wavelength within the range from 150 nm to 300 nm, inclusive of the endpoints, and at an angle of incidence within the range from 0 degrees to 75 degrees, inclusive of the endpoints. In embodiments, the anti-reflective coating may comprise a reflectance less than or equal to 0.5%, less than or equal to 0.4%, less than or equal to 0.3%, less than or equal to 0.2%, or even less than or equal to 0.1%, as measured at a wavelength within the range from 150 nm to 300 nm, inclusive of endpoints, and at an angle of incidence within the range from 0 degrees to 75 degrees, inclusive of endpoints. One skilled in the art would appreciate that the reflectance achieved at a given angle is dependent on the design of the coating.

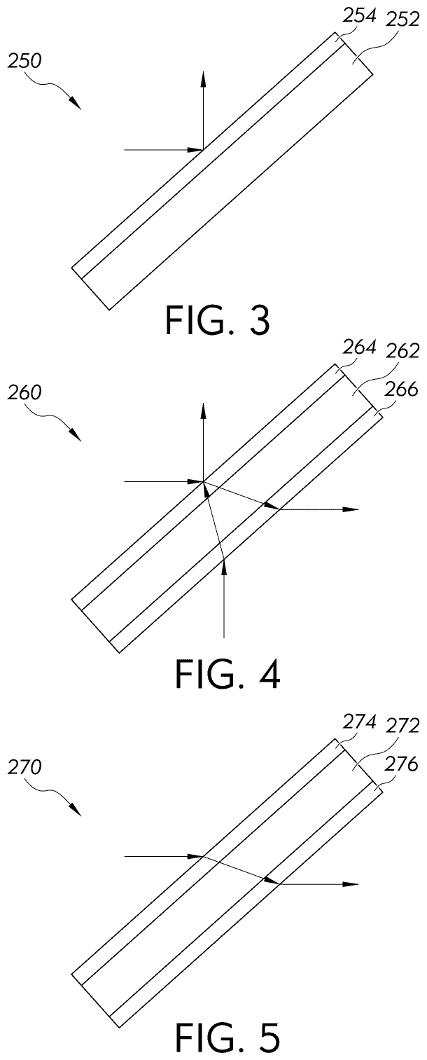

In embodiments, the coating 104 may comprise a reflective coating such as a partial-reflective coating. FIG. 3 shows one such embodiment in which an optical element is shown at 250. The optical element 250 includes a substrate 252 and a partial-reflective coating 254 (wherein the partial reflective coating 254 comprises coating 104 or 204 as disclosed above). The optical element 250 reflects radiation as shown by the arrows. In embodiments, the coating 104 may comprise a partial-reflective coating comprising a reflectance of greater than or equal to 0.5%, as measured at a wavelength within a range from 150 nm to 300 nm, inclusive of the endpoints, and at an angle of incidence within a range from 0 degrees to 75 degrees, inclusive of the endpoints. In embodiments, the coating 104 may comprise a partial-reflective coating comprising a reflectance of greater than or equal to 0.5%, as measured at every wavelength within the range from 150 nm to 300 nm, inclusive of the endpoints, and at an angle of incidence within the range from 0 degrees to 75 degrees, inclusive of the endpoints. In embodiments, the partial-reflective coating may comprise a reflectance greater than or equal to 0.5%, greater than or equal to 1%, greater than or equal to 5%, greater than or equal to 10%, greater than or equal to 25%, greater than or equal to 50%, greater than or equal to 75%, or even greater than or equal to 95%, as measured at a wavelength within the range from 150 nm to 300 nm, inclusive of the endpoints, and at an angle of incidence within the range from 0 degrees to 75 degrees, inclusive of the endpoints. In embodiments, the partial-reflective coating may comprise a reflectance greater than or equal to 95%, as measured at a wavelength within the range from 150 nm to 300 nm, inclusive of the endpoints, and at an angle of incidence within the range from 0 degrees to 75 degrees, inclusive of the endpoints, thereby forming a beam splitter.

In embodiments, the coating 104 may be highly reflective (e.g., reflectance of about 100%, as measured at a wavelength within a range from 150 nm to 300 nm, inclusive of the endpoints, and at an angle of incidence within a range from 0 degrees to 75 degrees, inclusive of the endpoints), thereby forming a mirror. In embodiments, the coating 104 may be highly reflective with a reflectance of about 100%, as measured at every wavelength within the range from 150 nm to 300 nm, inclusive of the endpoints, and at an angle of incidence within a range from 0 degrees to 75 degrees, inclusive of the endpoints, thereby forming the mirror.

In embodiments, the coating 104 may comprise an anti-reflective coating comprising a reflectance less than or equal to 0.5%, as measured at a wavelength of 193 nm and at an angle of incidence of 45 degrees. In embodiments, the coating 104 may comprise a partial-reflective coating comprising a reflectance greater than or equal to 0.5%, as measured at a wavelength of 193 nm and at an angle of incidence of 45 degrees. In embodiments, the coating 104 may be highly reflective (e.g., reflectance of about 100%, as measured at a wavelength of 193 nm and at an angle of incidence of 45 degrees).

While FIG. 1 illustrates an optical element 100 with a coating 104 on a first major surface 102a of the substrate 102, it should be understood that the coating 104 may comprise a first coating disposed on the first major surface 102a and a second coating disposed on a second major surface 102b of the substrate 102 opposite the first major surface 102a. In embodiments, the coating 104 may comprise a partial-reflective coating disposed on the first major surface 102a of the substrate 102 and an anti-reflective coating disposed on the second major surface 102b of the substrate 102. For example, referring now to FIG. 4, an optical element is shown at 260. The optical element 260 includes a substrate 262, a partial-reflective coating 264 on a first major surface of the substrate 262, and an anti-reflective coating 266 on a second major surface of the substrate 262, thereby forming a beam splitter. The optical element 260 reflects radiation as shown by the arrows. In other embodiments, the coating 104 may comprise a first anti-reflective coating disposed on a first major surface 102a of the substrate 102 and a second anti-reflective coating disposed on a second major surface 102b of the substrate 102 opposite the first major surface 102a. For example, referring now to FIG. 5, an optical element is shown at 270. The optical element includes a substrate 272, a first anti-reflective coating 274 disposed on a first major surface of the substrate 272, and a second anti-reflective coating 276 disposed on a second major surface of the substrate 272, thereby forming a laser window. The optical element 270 reflects radiation as shown by the arrows. It is noted that the first first anti-reflective coating 274 may be the same or different as the second anti-reflective coating 276 (according to the embodiments disclosed herein).

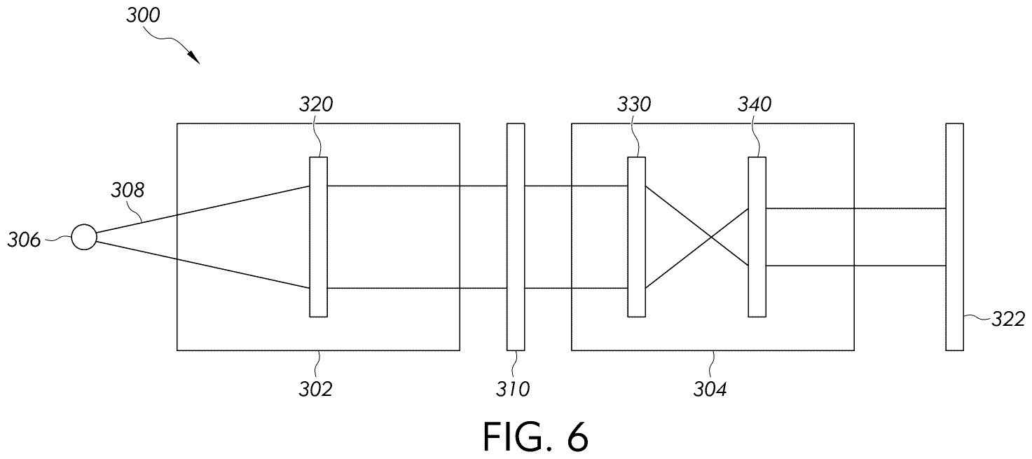

In embodiments, an ultraviolet lithography system may comprise the optical element described herein. For example, referring now to FIG. 6, an ultraviolet lithography system is shown at 300. The UV lithography system 300 includes two optical systems 302 and 304, an illumination system 302 and a projection system 304. A radiation source 306 (e.g., an excimer laser), emits radiation 308 at a specific wavelength, for example, at 248 nm, 193 nm, or 157 nm. The radiation 308 emitted by the radiation source 206 may be conditioned with the aid of the illumination system 302 such that a mask 310 (e.g., reticle) may thereby be illuminated. For this purpose, the illumination system 302 may include at least one transmissive optical element. The optical element 320, for example, concentrates the radiation 308.

The mask 310 has on its surface a structure which is transferred to an element 322 to be exposed, for example, a wafer in the context of production of semiconductor components with the aid of the projection system 304. The projection system 304 also comprises at least one transmissive optical element. In the example illustrated here, two transmissive optical elements 330, 340, for example, reduce the structures on the mask 310 to the size desired for the exposure of the element 322. In the projection system 304, a wide variety of optical elements may be combined with one another in a known manner.

The optical elements 320, 330, and 340 illustrated in FIG. 6 may each comprise an optical element according to embodiments described herein. Moreover, in embodiments, radiation source 306 may include an optical element, such as a beam splitter, therein.

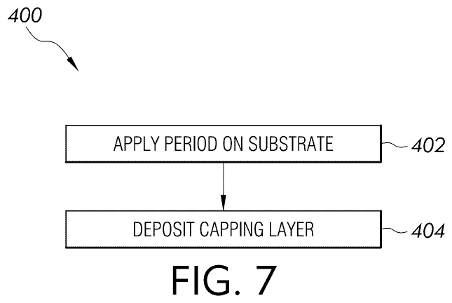

Referring now to FIG. 7, a method for making an optical element having a coating thereon is shown at 400. The method 400 being at block 402 with applying a period on a substrate. The period and the substrate may have the same or similar materials and properties as period 108 and substrate 102 described herein with respect to FIG. 1 (or as period 208 and substrate 208 described herein with respect to FIG. 2). For example, the period may comprise a high refractive index metal fluoride layer and a low refractive index metal layer. Each of the high refractive index metal fluoride material and the low refractive index material may be applied using a physical vapor deposition or a reactive sputtering process. In embodiments, each of the high refractive index metal fluoride material and the low refractive index material may be applied at a temperature greater than or equal to 200° C. and less than or equal to 300° C. to achieve a desired thermal densification while controlling the overall coating stress. In embodiments, each of the high refractive index metal fluoride material and the low refractive index material may be applied at a temperature greater than or equal to 200° C., greater than or equal to 220° C., greater than or equal to 240° C., or even greater than or equal to 260° C. In embodiments, each of the high refractive index metal fluoride material and the low refractive index material may be applied at a temperature less than or equal to 300° C., less than or equal to 280° C., less than or equal to 260° C., or even less than or equal to 240° C. In embodiments, each of the high refractive index metal fluoride material and the low refractive index material may be applied at a temperature greater than or equal to 200° C. and less than or equal to 300° C., greater than or equal to 200° C. and less than or equal to 280° C., greater than or equal to 200° C. and less than or equal to 260° C., greater than or equal to 200° C. and less than or equal to 240° C., greater than or equal to 220° C. and less than or equal to 300° C., greater than or equal to 220° C. and less than or equal to 280° C., greater than or equal to 220° C. and less than or equal to 260° C., greater than or equal to 220° C. and less than or equal to 240° C., greater than or equal to 240° C. and less than or equal to 300° C., greater than or equal to 240° C. and less than or equal to 280° C., greater than or equal to 240° C. and less than or equal to 260° C., greater than or equal to 260° C. and less than or equal to 300° C., or even greater than or equal to 260° C. and less than or equal to 280° C., or any and all sub-ranges formed from any of these endpoints.

The step of applying the period on the substrate at block 402 may be repeated until a desired number of periods are deposited on the substrate.

Referring back to FIG. 7, the method 400 continues at block 404 with depositing a capping layer. The capping layer may have the same or similar materials and properties as capping layer 110 described herein with respect to FIG. 1 (or as capping layer 210 described with reference to FIG. 2). In particular, the capping layer may comprise a density greater than 2.20 g/cm³ and less than 2.28 g/cm³ to achieve a coating having improved environmental stability while maintaining laser durability. The desired density may be achieved by depositing the capping layer at a temperature greater than or equal to 200° C. and less than 300° C. and using ion treatment.

In embodiments, the capping layer may be deposited at a temperature greater than or equal to 200° C. and less than 300° C. In embodiments, the capping layer may be deposited at a temperature greater than or equal to 220° C. and less than or equal to 280° C. In embodiments, the capping layer may be deposited at a temperature greater than or equal to 200° C., greater than or equal to 220° C., greater than or equal to 240° C., or even greater than or equal to 260° C. In embodiments, the capping layer may be deposited at a temperature less than 300° C., less than or equal to 280° C., less than or equal to 260° C., or even less than or equal to 240° C. In embodiments, the capping layer may be deposited at a temperature greater than or equal to 200° C. and less than 300° C., greater than or equal to 200° C. and less than or equal to 280° C., greater than or equal to 200° C. and less than or equal to 260° C., greater than or equal to 200° C. and less than or equal to 240° C., greater than or equal to 220° C. and less than 300° C., greater than or equal to 220° C. and less than or equal to 280° C., greater than or equal to 220° C. and less than or equal to 260° C., greater than or equal to 220° C. and less than or equal to 240° C., greater than or equal to 240° C. and less than 300° C., greater than or equal to 240° C. and less than or equal to 280° C., greater than or equal to 240° C. and less than or equal to 260° C., greater than or equal to 260° C. and less than to 300° C., or even greater than or equal to 260° C. and less than or equal to 280° C., or any and all sub-ranges formed from any of these endpoints.

In embodiments, the ion treatment may comprise in-situ or post-deposition plasma ion treatment. In embodiments, the plasma ion treatment may comprise an advanced plasma source comprising a voltage greater than 110 V and less than or equal to 160 V to achieve a desired density (e.g., greater than or equal to 2.20 g/cm³ and less than 2.28 g/cm³). In embodiments, the advanced plasma source may comprise a voltage greater than 110 V, greater than or equal to 120 V, or even greater than or equal to 130 V. In embodiments, the advanced plasma source may comprise a voltage less than or equal to 160 V, less than or equal to 150 V, or even less than or equal to 140 V. In embodiments, the advanced plasma source may comprise a voltage greater than 110 V and less than or equal to 160 V, greater than 110 V and less than or equal to 150 V, greater than 110 V and less than or equal to 140 V, greater than or equal to 120 V and less than or equal to 160 V, greater than or equal to 120 V and less than or equal to 150 V, greater than or equal to 120 V and less than or equal to 140 V, greater than or equal to 130 V and less than or equal to 160 V, greater than or equal to 130 V and less than or equal to 150 V, or even greater than or equal to 130 V and less than or equal to 140 V, or any and all sub-ranges formed from any of these endpoints.

### EXAMPLES

In order that various embodiments be more readily understood, reference is made to the following examples, which are intended to illustrate various embodiments of the optical elements according to embodiments described herein.

### Environmental Stability

Three optical elements, Comparative Optical Element C1 and Example Optical Elements E1 and E2, were made. Specifics of Comparative Optical Element C1 and Example Optical Elements E1 and E2 and application parameters thereof are shown in Table 1.

TABLE 1

| | C1 | E1 | E2 |
|---|---|---|---|
| Substrate | CaF₂ | CaF₂ | CaF₂ |
| Coating Type | partial-reflective | partial-reflective | anti-reflective |
| Periods | 3 | 3 | 1 |
| Low RI Metal Fluoride Layer | 38.3 nm AlF₃ | 38.3 nm AlF₃ | 24 nm AlF₃ |
| High RI Metal Fluoride Layer | 27.6 nm GdF₃ | 27.6 nm GdF₃ | 30 nm GdF₃ |
| Another Low RI | 72.3 nm AlF₃ | 72.3 nm AlF₃ | 45 nm AlF₃ |
| Metal Fluoride Layer | | | |
| Metal Fluoride Application | 250 | 300 | 300 |
| Temperature (° C.) | | | |
| Capping Layer | SiO₂ | SiO₂ | SiO₂ |
| Capping Layer Density (g/cm³) | 2.17 | 2.25 | 2.25 |
| Capping Layer Refractive | 1.554 | 1.571 | 1.571 |
| Index | | | |
| Capping Layer Application | 120 | 250 | 250 |
| Temperature (° C.) | | | |
| Capping Layer Plasma Ion | 110 | 140 | 140 |
| Treatment Voltage (V) | | | |

Comparative Optical Element C1 included a CaF₂ substrate and a partial-reflective coating. The partial-reflective coating of Comparative Optical Element C1 included, in an order moving away from the substrate, 3 periods of a 38.3 nm thick AlF₃ layer (low refractive index metal fluoride layer) and a 27.6 nm thick GdF₃ layer (high refractive index metal fluoride layer), a 72.3 nm thick AlF₃ layer (low refractive index metal fluoride layer), and an 82 nm thick SiO₂ capping layer having a density of 2.17 g/cm³ and a refractive index of 1.554. The AlF₃ and GdF₃ layers were applied at 250° C. The SiO₂ capping layer was applied at 120° C. with plasma ion treatment having a voltage of 110 V. The partial-reflective coating of Comparative Optical Element C1 was different from the coatings and methods of making optical elements according to embodiments described herein in that the capping layer of the partial-reflective coating of Comparative Optical Element C1 had a density of 2.17 g/cm³, outside the range of greater than or equal to 2.20 g/cm³ and less than 2.28 g/cm³, a refractive index of 1.554, outside the range of greater than or equal to 1.56 and less than 1.58, and was applied with plasma ion treatment having a volatage of 110 V, outside the range of greater than 110 V and less than or equal to 160 V.

Example Optical Element E1 included a CaF₂ substrate and a partial-reflective coating. The partial-reflective coating of Example Optical Element E1 included, in an order moving away from the substrate, 3 periods of a 38.3 nm thick AlF₃ layer (low refractive index metal fluoride layer) and a 27.6 nm thick GdF₃ layer (high refractive index metal fluoride layer), a 72.3 nm thick AlF₃ layer (low refractive index metal fluoride layer), and an 82 nm thick SiO₂ capping layer having a density of 2.25 g/cm³ and a refractive index of 1.571. The AlF₃ and GdF₃ layers were applied at 300° C. The SiO₂ capping layer was applied at 250° C. with plasma ion treatment having a voltage of 140 V.

Example Optical Element E2 included a CaF₂ substrate and an anti-reflective coating. The anti-reflective coating of Example Optical Element E2 included, in an order moving away from the substrate, 1 period of a 24 nm thick AlF₃ layer (low refractive index metal fluoride layer) and a 30 nm thick GdF₃ layer (high refractive index metal fluoride layer), a 45 nm thick AlF₃ layer (low refractive index metal fluoride layer), and an 67 nm thick SiO₂ capping layer having a density of 2.25 g/cm³ and a refractive index of 1.571. The AlF₃ and GdF₃ layers were applied at 300° C. The SiO₂ capping layer was applied at 250° C. with plasma ion treatment having a voltage of 140 V.

Referring now to FIGS. 8 and 9, the reflectance of the optical elements at an angle of incidence of 45° C. and a wavelength range of 180 nm to 220 nm was measured. The optical elements were then exposed to humidity conditions and the reflectance was measured again after the exposure. Comparative Optical Element C1 was exposed to about 25° C. and 45% RH (relative humidity) for two months. Example Optical Elements E1 and E2 were exposed to accelerated humidity conditions at 80° C. and 80% RH for 6 hours.

As shown in FIG. 8, the spectral shift for Comparative Optical Element C1, from the pre-humidity exposure to the post-humidity exposure, was about 6 nm. The capping layer of Comparative Optical Element C1 had a porosity of about 5%. As shown in FIG. 9, the spectral shift for Example Optical Element E1, from the pre-humidity exposure to the post-humidity exposure, was about 0.2 nm. As also shown in FIG. 9, the spectral shift for Example Optical Element E2, from the pre-humidity exposure to the post-humidity exposure, was about 0.1 nm. The capping layers of Example Optical Elements E1 and E2 had a porosity of about 1%, which is much lower than that of Comparative Optical Element C1, and, thus, achieved lower spectral shifts from the pre-humidty to post-humidity exposures. As exemplified by FIGS. 8 and 9, optical elements having a capping layer comprising a density greater than or equal to 2.20 g/cm³ and less than 2.28 g/cm³ achieve a relatively low porosity, which results in improved environmental stability.

### Laser Durability

Two optical elements, Comparative Optical Element C2 and Example Optical Element E3, were made. Specifics of Comparative Optical Element C2 and Example Optical Element E3 and application parameters thereof are shown in Table 2.

TABLE 2

| | C2 | | E3 | |
|---|---|---|---|---|
| Substrate | CaF₂ | | CaF₂ | |
| Coating Type | partial- | anti- | partial- | anti- |
| | reflective | reflective | reflective | reflective |
| Periods | 3 | 1 | 3 | 1 |
| Low RI Metal Fluoride Layer | 38.3 nm AlF₃ | 24 nm AlF₃ | 38.3 nm AlF₃ | 24 nm AlF₃ |
| High RI Metal Fluoride Layer | 27.6 nm GdF₃ | 30 nm GdF₃ | 27.6 nm GdF₃ | 30 nm GdF₃ |
| Another Low RI | 72.3 nm AlF₃ | 45 nm AlF₃ | 72.3 nm AlF₃ | 45 nm AlF₃ |
| Metal Fluoride Layer | | | | |
| Metal Fluoride Application | 300 | 300 | 300 | 300 |
| Temperature (° C.) | | | | |
| Capping Layer | SiO₂ | SiO₂ | SiO₂ | SiO₂ |
| Capping Layer Density (g/cm³) | 2.28 | 2.28 | 2.25 | 2.25 |
| Capping Layer RI | 1.577 | 1.577 | 1.57 | 1.57 |
| Capping Layer Application | 300 | 300 | 250 | 250 |
| Temperature (° C.) | | | | |
| Capping Layer Plasma Ion | 140 | 110 | 140 | 140 |
| Treatment Voltage (V) | | | | |

Comparative Optical Element C2 included a CaF₂ substrate, a partial-reflective coating on one side of the substrate, and an anti-reflective coating on an opposite side of the substrate.

The partial-reflective coating of Comparative Optical Element C2 included, in an order moving away from the substrate, 3 periods of a 38.3 nm thick AlF₃ layer (low refractive index metal fluoride layer) and a 27.6 nm thick GdF₃ layer (high refractive index metal fluoride layer), a 72.3 nm thick AlF₃ layer (low refractive index metal fluoride layer), and an 82 nm thick SiO₂ capping layer having a density of 2.28 g/cm³ and a refractive index of 1.577. The AlF₃ and GdF₃ layers of the partial-reflective coating of Comparative Optical Element C2 were applied at 300° C. The SiO₂ capping layer of the partial-reflective coating of Comparative Optical Element C2 was applied at 300° C. with plasma ion treatment having a voltage of 140 V. The partial-reflective coating of Comparative Optical Element C2 was different from the coatings and methods of making optical elements according to embodiments described herein in that the capping layer of the partial-reflective coating of Comparative Optical Element C2 had a density of 2.28 g/cm³, outside the range of greater than or equal to 2.20 g/cm³ and less than 2.28 g/cm³, and was applied at 300° C., outside the range of greater than or equal to 200° C. and less than 300° C.

The anti-reflective coating of Comparative Optical Element C2 included, in an order moving away from the substrate, 1 period of a 24 nm thick AlF₃ layer (low refractive index metal fluoride layer) and a 30 nm thick GdF₃ layer (high refractive index metal fluoride layer), a 45 nm thick AlF₃ layer (low refractive index metal fluoride layer), and an 82 nm thick SiO₂ capping layer having a density of 2.28 g/cm³ and a refractive index of 1.577. The AlF₃ and GdF₃ layers of the anti-reflective coating of Comparative Optical Element C2 were applied at 300° C. The SiO₂ capping layer of the anti-reflective capping layer of C2 was applied at 300° C. with plasma ion treatment having a voltage of 110 V. The anti-reflective coating of Comparative Optical Element C2 was different from the coatings and methods of making optical elements according to embodiments described herein in that the capping layer of the anti-reflective coating of Comparative Optical Element C2 had a density of 2.28 g/cm³, outside the range of greater than or equal to 2.20 g/cm³ and less than 2.28 g/cm³, was applied at 300° C., outside the range of greater than or equal to 200° C. and less than 300° C., and was applied with plasma ion treatment having a volatage of 110 V, outside the range of greater than 110 V and less than or equal to 160 V.

Example Optical Element E3 included a CaF₂ substrate, a partial-reflective coating on one side of the substrate, and an anti-reflective coating on the opposite side of the substrate.

The partial-reflective coating of Example Optical Element E3 included, in an order moving away from the substrate, 3 periods of a 38.3 nm thick AlF₃ layer (low refractive index metal fluoride layer) and a 27.6 nm thick GdF₃ layer (high refractive index metal fluoride layer), a 72.3 nm thick AlF₃ layer (low refractive index metal fluoride layer), and an 82 nm thick SiO₂ capping layer having a density of 2.25 g/cm³ and a refractive index of 1.57. The AlF₃ and GdF₃ layers of the partial-reflective coating of Example Optical Element E3 were applied at 300° C. The SiO₂ capping layer of the partial-reflective coating of Example Optical Element E3 was applied at 250° C. with plasma ion treatment having a voltage of 140 V.

The anti-reflective coating of Example Optical Element E3 included, in an order moving away from the substrate, 1 period of a 24 nm thick AlF₃ layer (low refractive index metal fluoride layer) and a 30 nm thick GdF₃ layer (high refractive index metal fluoride layer), a 45 nm thick AlF₃ layer (low refractive index metal fluoride layer), and an 82 nm thick SiO₂ capping layer having a density of 2.25 g/cm³ and a refractive index of 1.57. The AlF₃ and GdF₃ layers of the anti-reflective coating of Example Optical Element E3 were applied at 300° C. The SiO₂ capping layer of the anti-reflective capping layer of Example Optical Element E3 was applied at 250° C. with plasma ion treatment having a voltage of 140 V.

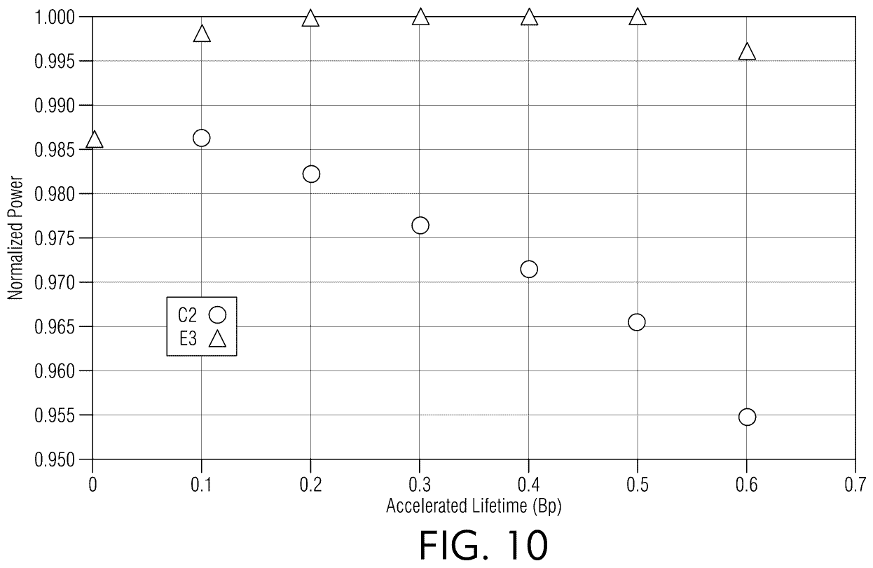

Referring now to FIG. 10, the optical elements were subjected to accelerated laser damage test (ALDT). In particular, an ALDT test bench was used to simultaneously test Comparative Optical Element C2 and Example Optical Element E3 with an elevated high laser fluence (i.e., to accelerate test time). The power meter reading was monitored for the laser beam passing through the optical elements over the laser beam shot counts (in Bp) in each beam path and normalized to the test start point. As shown in FIG. 10, the normalized power of Example Optical Element E3 degraded less than 0.5% after an accelerated lifetime of 0.6 Bp, where as the normalized power of Comparative Optical Element C2 degraded 3% after an accelerated lifetime of only 0.4 Bp. As exemplified by FIG. 10, optical elements having a capping layer comprising a density greater than or equal to 2.20 g/cm³ and less than 2.28 g/cm³ achieve maintained laser durability.

It will be apparent to those skilled in the art that various modifications and variations may be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

What is claimed is:

1. An optical element comprising:
a substrate; and
a coating supported by the substrate,
wherein the coating comprises, in an order moving away from the substrate:
a period comprising a high refractive index metal fluoride layer and a low refractive index metal fluoride layer; and
a capping layer comprising SiO₂, F—SiO₂, or a combination thereof, the capping layer comprising a density greater than or equal to 2.20 g/cm³ and less than 2.28 g/cm³.

2. The optical element of claim 1, wherein the capping layer comprises a density greater than or equal to 2.22 g/cm³ and less than or equal to 2.26 g/cm³.

3. The optical element of claim 1, wherein the capping layer comprises a porosity less than or equal to 2%.

4. The optical element of claim 1, wherein the capping layer comprises a refractive index greater than or equal to 1.56 and less than 1.58.

5. The optical element of claim 1, wherein the capping layer comprises a thickness greater than or equal to 30 nm and less than or equal to 100 nm.

6. The optical element of claim 1, wherein the high refractive index metal fluoride layer comprises a refractive index greater than 1.60.

7. The optical element of claim 1, wherein the low refractive index metal fluoride layer comprises a refractive index greater than or equal to 1.35 and less than or equal to 1.60.

8. The optical element of claim 1, wherein the coating comprises, in an order moving away from the substrate:
the high refractive index metal fluoride layer;
the low refractive index metal fluoride layer; and
the capping layer.

9. The optical element of claim 1, wherein the coating comprises, in an order moving away from the substrate:
the low refractive index metal fluoride layer;
the high refractive index metal fluoride layer; and
the capping layer.

10. The optical element of claim 9, wherein the coating further comprises another low refractive index metal fluoride layer disposed between the high refractive index metal fluoride layer and the capping layer.

11. The optical element of claim 1, wherein the coating comprises a plurality of the periods such that the high refractive index metal fluoride layer and the low refractive index metal fluoride layer alternate.

12. The optical element of claim 11, wherein the coating comprises greater than or equal to 1 period and less than or equal to 10 periods.

13. The optical element of claim 1, wherein the high refractive index metal fluoride layer comprises GdF₃, LaF₃, or a combination thereof.

14. The optical element of claim 1, wherein the low refractive index metal fluoride layer comprises AlF₃, MgF₂, CaF₂, LiF, SiO₂, F—SiO₂, or a combination thereof.

15. The optical element of claim 1, wherein each of the high refractive index metal fluoride layer and the low refractive index metal fluoride layer comprise a thickness greater than or equal to 10 nm and less than or equal to 80 nm.

16. The optical element of claim 1, wherein the coating comprises an anti-reflective coating, the anti-reflective coating comprising a reflectance less than or equal to 0.5%, as measured at a wavelength within a range from 150 nm to 300 nm, inclusive of endpoints, and at an angle of incidence within a range from 0 degrees to 75 degrees, inclusive of endpoints.

17. The optical element of claim 1, wherein the coating comprises a partial-reflective coating, the partial-reflective coating comprising a reflectance greater than or equal to 0.5%, as measured at a wavelength within a range from 150 nm to 300 nm, inclusive of endpoints, and at an angle of incidence within a range from 0 degrees to 75 degrees, inclusive of endpoints.

18. The optical element of claim 1, wherein the coating comprises a first anti-reflective coating disposed on a first major surface of the substrate and a second anti-reflective coating disposed on a second major surface of the substrate opposite the first major surface, each of the first anti-reflective coating and the second anti-reflective coating comprising a reflectance less than or equal to 0.5%, as measured at a wavelength within a range from 150 nm to 300 nm, inclusive of endpoints, and at an angle of incidence within a range from 0 degrees to 75 degrees, inclusive of endpoints.

19. The optical element of claim 1, wherein the coating comprises a thickness greater than or equal to 75 nm and less than or equal to 500 nm.

20. The optical element of claim 1, wherein the substrate comprises MgF₂, CaF₂, SiO₂, F—SiO₂, or a combination thereof.
